(19) United States
(12) Patent Application Publication
(10) Pub. No.: US 2005/0147264 A1
(43) Pub. Date: Jul. 7, 2005

(54) Piezoelectric speaker

(76) Inventor: Min-Su Yeo, Gyeonggi-do (KR)

Correspondence Address: DUANE MORRIS, LLP;IP DEPARTMENT, ONE LIBERTY PLACE, PHILADELPHIA, PA, 19103-7396, US

(21) Appl. No.: 10/823,312

(22) Filed: Apr. 13, 2004

(30) Foreign Application Priority Data
Jan. 2, 2004 (KR) 10-2004-0000033

(51) Int. Cl. H04R 25/00

(52) U.S. Cl. 381/190; 381/173; 381/191

(57) ABSTRACT

A piezoelectric speaker has a body, a reflective cover and a lower cover so as to increase durability and generate effective sound waves. A piezoelectric speaker has a body having a bottom portion defining a throttle hole in the center and a circular sidewall in the periphery, a reflection cover over and spaced to the body, a lower cover connected to the lower plane of the body and a piezoelectric transducer element including a metal disc forming a passing hole through a part of it and a piezoelectric element attached to the metal disc.

This application claims the benefit of Korean Patent Application No. 2004-0000033, filed on Jan. 2, 2004 in Korea, which is hereby incorporated by reference for all purposes as if fully set forth herein.

### BACKGROUND OF THE INVENTION

1. Field of the Invention

The present invention relates to a piezoelectric speaker, and more particularly, to a piezoelectric speaker used in a burglar alarm device mounted in vehicles.

2. Discussion of the Related Art

Generally, a speaker used in vehicles should have a small volume and a light weight and particularly it should have output sound pressure of at least 60 dB in a commonly used frequency range (1,500 to 4,000 Hz). Besides, the speaker should have an output property, that is, maximal peak sound pressures of about 100 dB in the frequency range so that drivers within a 4-kilometer radius of the speaker should sense the warning sounds. A piezoelectric speaker has been widely used to satisfy those requirements.

The piezoelectric speaker comprises a piezoelectric element having piezoelectric effect such as Rochelle salts, barium titanate, and ceramic. While a low-frequency power is applied to the element, a diameter of the element changes periodically according to the periodic change of the polarity of the low frequency signal.

To take advantage of the change of the diameter of the element, a thin metal disc is bonded to the element. The disc acts as a spring and moves vertically according to the change of the diameter of the element to produce a sound. The piezoelectric element having the bonded disc is called as a piezoelectric transducer element.

An example of such a piezoelectric speaker is disclosed in U.S. Pat. No. 4,979,219. As shown in FIG. 1, the piezoelectric speaker mainly includes a body 10, a reflection cover 20 secured to the top of the body 10, a lower cover 30 fastened to the bottom portion of the body 10, a diaphragm 50 inserted into a space between the body 10 and the lower cover 30, and a piezoelectric transducer element 60 attached to one plane of the diaphragm 50.

More specifically, the circular shaped body 10 includes a sidewall 11 having a sloped inner sidewall 11a. The body 10 has a wavy upper surface and defines a throttle hole 70 axially through its central portion.

The reflection cover 20 includes a tip 22 in the lower center and a wavy inner surface of which the contours 24 are corresponding to the contours of the opposing surface of the mid plate 19. The reflection cover 20 is mounted on the sloped inner sidewall 11a of the body 10 and defines a plurality of discharge openings 90 between the reflection cover 20 and the sidewall 11 of the body 10.

The lower cover 30 has a circular bottom portion and a peripheral sidewall and is fastened in the body 10 by inserting its upper end into the inner side of the protrusion 16 formed on a lower plane of the body bottom by means of press fit.

The piezoelectric transducer element 60 comprises a circular copper disc 62 of smaller diameter than the diaphragm 50 and a ceramic disc 64 of even smaller diameter attached to lower plane of the copper disc 60, each of the copper disc 62 and the ceramic disc 64 are connected to a wire for applying an electric signal. The ceramic disc 64 is a piezoelectric element.

When an electric power is applied to the piezoelectric transducer element 60 consisting of the copper disc 60 and the ceramic disc 62, the whole piezoelectric transducer element 60 vibrates since the ceramic disc 64 expands and contracts periodically. The diaphragm 50 of larger diameter than the piezoelectric transducer element 60 is attached to the piezoelectric transducer element amplifies the sound pressures of the vibration. Usually, the diaphragm 50 is made of paper and its equivalent material for wet-proof. The diaphragm 50 is fixed between the upper end of the sidewall of the lower cover 30 and the rim 17 formed in the lower plane of the body 10, and the lower cover 30 and the body 10 is combined by means of press fit.

As the piezoelectric transducer element 60 and the diaphragm 50 attached to the element 60 are vibrated owing to a low-frequency signal applied from the outside, air in a first space 40 between the body 10 and the diaphragm 50 is subsequently vibrated. The air vibration in a first space 40 passes through the throttle hole 70 to vibrate the air in a second space 80 between the body 10 and the reflection cover 20. As the sound pressures are amplified and the sound waves are changed to curved forms in the second space 80 between the body 10 and the reflection cover 20, the sound waves are transmitted radially into the outside through a plurality of the sound discharge openings uniformly formed between the sidewall 11 of the body 10 and the reflection cover 20.

By the way, the conventional piezoelectric speaker has complicated contours of the body 10 and the reflection cover 20, and thus requires an additional manufacturing process. Also a separate diaphragm 50 to amplify the vibration is necessary, and further the diaphragm does not last long since the diaphragm 50 is usually made of coated paper.

Furthermore, since the body 10 and the lower cover 30 are connected by means of press fit, connection between the body and the lower cover becomes loose owing to the vibration of the piezoelectric transducer element.

### SUMMARY OF THE INVENTION

Accordingly, the present invention is directed to a piezoelectric speaker that substantially obviates one or more of problems due to limitations and disadvantages of the related art.

An advantage of the present invention is to provide a piezoelectric speaker that has simpler components and reduces a manufacturing process and cost.

Another advantage of the present invention is to provide a piezoelectric speaker that has an excellent durability and generates more effective warning sounds.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, a piezoelectric speaker comprises a body including a bottom portion having a throttle hole in the center and a sidewall of a predetermined height formed in bottom portion periphery, contours of the bottom portion being curved from an upper periphery of the throttle hole to the sidewall, a reflection cover of an upper position to the body, defining a space to the body, forming a tip in the lower central portion and having a connection rod in a part of the lower central portion for connecting to the body, contours of the lower central portion being curved from the tip to a periphery of the reflection cover, a lower cover inserted into the bottom portion of the body including a plate-formed bottom portion and a circular sidewall formed on a periphery of the plate-formed bottom portion, and a piezoelectric transducer element positioned between the body and the lower cover comprising a metal plate having a passing hole and a piezoelectric element attached to one plane of the metal plate, each of the metal plate and the piezoelectric element is connected to wire for applying an electric signal.

Preferably, the contours of the body bottom portion comprises an concave formed from the upper periphery of the throttle hole to the body sidewall and the contours of the lower reflection cover has wavy shape corresponding to the contours of the body bottom portion. Particularly, the body and the lower cover are connected by ultrasonic welding or by molding a boundary between the body and the lower cover using epoxy resins. The metal plate is circular plate, preferably made of materials selected from the group consisting of brass, stainless steel, or nickel alloy.

Also, the passing hole of the metal plate are preferably formed a central position between the periphery of the metal plate and the periphery of the piezoelectric element and has a diameter of about 4 to about 6 mm. In addition, the piezoelectric element has disc shape, preferably a thickness of about 24 to 26 mm and a diameter of about 0.15 to 0.25 mm, and particularly made of ceramics.

Both of the metal plate and the piezoelectric element are connected to wires at bonding portions, both of which are formed on the same line from a center of the piezoelectric transducer element. The bonding portions are formed at the location of about 170 to 190 degrees to the passing hole around the center of the piezoelectric transducer element, and preferably formed at the opposite position to the passing hole. Surfaces of the bonding portions are treated with UV coatings.

It is another aspect of the present invention to provide a piezoelectric speaker comprising: a body including a bottom portion and a circular sidewall, the bottom portion having a throttle hole in a center thereof, wherein a upper surface from the throttle hole to side wall has a curve contour; a reflection cover located over and spaced from the body, the reflection cover having a tip at a lower center and a lower plane having waving contours from the tip to a periphery of the reflection cover; a means for fixing the body and the reflection cover; a lower cover having a plate-shaped bottom portion and a sidewall formed on a periphery thereof, the lower cover being connected to the body; and a piezoelectric transducer element inserted between the body and the lower cover, the piezoelectric transducer element including a metal disc having a passing hole and a piezoelectric element attached to the metal disc, each of the metal disc and the piezoelectric element connected to wires.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional view of a conventional piezoelectric speaker;

FIG. 2 is a cross-sectional view of a piezoelectric speaker according to the present invention;

FIG. 3 is a perspective view showing a connection between a body and a reflection cover of a piezoelectric speaker according to the present invention;

FIG. 4A is a perspective view showing a lower portion of a body a piezoelectric speaker according to the present invention;

FIG. 4B is a perspective view showing a lower cover of a piezoelectric speaker according to the present invention;

FIG. 5 is a plane view of a piezoelectric speaker according to the present invention;

FIG. 6 is a side view of piezoelectric speaker mounted into a case according to the present invention;

FIG. 7 is a circuitry applying an electric signal into a piezoelectric speaker according to the present invention; and

FIG. 8 is a graph showing output sound pressures in changing a frequency of a piezoelectric speaker according to an embodiment of the present invention.

### DETAILED DESCRIPTION OF THE ILLUSTRATED EMBODIMENTS

Reference will now be made in detail to the illustrated embodiment of the present invention, which is illustrated in the accompanying drawings.

FIG. 2 is a cross-sectional view of a piezoelectric speaker according to the present invention. As shown in the figure, the speaker includes a body 100, a reflection cover 200 located in an upper position of the body 100, a lower cover 300 connected to a bottom portion 120 of the body 100, and a piezoelectric transducer element 150 inserted between the body 100 and the lower cover 300.

More specifically, the bottom portion 120 of the body 100 has a throttle hole 160 in the center and a sidewall 110 on a periphery has a sloped inner surface 112. The bottom portion 120 includes a convex 122 formed on a top edgy of the throttle hole 160 and a concave 124 formed between the convex 122 and the sidewall 110. The circular concave 124 are formed between the circular convex 122 and the sidewall 110 and the circular convex 122 approximately corresponds to the periphery of the throttle hole 160.

A circular protrusion 126 with a predetermined height is formed downwardly along a periphery of the body 100, and a circular rim 128 of a less height than the protrusion 126 is formed adjacent to an inside of the protrusion 126.

The reflection cover 200 includes a tip 210 at a lower central portion, a concave 212 and a convex 214, each of which corresponds to the upper contours of the bottom portion 120 of the body 100. The concave 212 and the convex 214 are circular shaped and the reflection cover 210 has a wavy lower surface. A first space 162 is defined as the space between the piezoelectric transducer element 150 and the bottom portion 120 of the body. A second space 164 is defined as the space between the body 100 and the reflection cover 200. The second space 164 amplifies sound wave pressures transmitted through the throttle hole 160 from a first space 162.

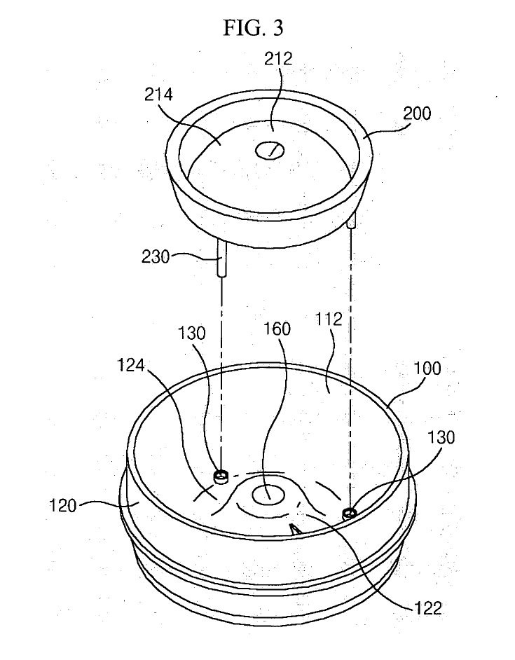

FIG. 3 is perspective view showing a connection between a body and a reflection cover of a piezoelectric speaker according to the present invention. As shown in the figure, a plurality of connection rods 230 extend downwardly underneath the reflection cover 200 and a plurality of connection holes 130 corresponding to the connection rods 230 are formed on a top plane of the bottom portion 120 of the body 100 for fixing the reflection cover 200 to the body 100. Preferably, the connection rods 230 extend from the circular concave 214 and the connection holes 130 are formed on the convex 124 of the bottom portion 120. The reflection cover 200 can be fixed to the body 100 by inserting the connection rods 230 into the connection holes 130. However, this is just a possible example for fixing the reflection cover 200, it is possible to fix the reflection cover 200 to the body 100 using other ways. For example, the connection rods 230 can be formed at the concave 212 of the reflection cover 200 and the connection holes 130 corresponding to the connection rods 230 can be formed at the convex 122, which is the periphery of the throttle hole 160. Besides, the tip 210 formed at the central lower plane of the reflection cover 200 helps to discharge sound waves transmitted from the throttle hole 160 to the outside.

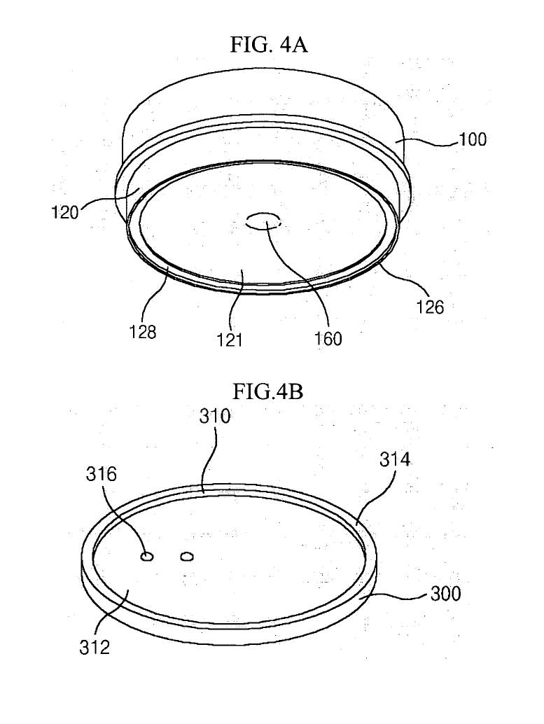

FIG. 4A is a perspective view showing a lower portion 121 of the body 100. As shown in the figure, the protrusion 126 with a predetermined height is protruded downwardly along the lower periphery of the body 100, and the circular rim 128 of a less height than the protrusion 126 is formed adjacent to an inside of the protrusion 126. In other words, the lower plane of the bottom portion 120 of the body 100 has a double-extended side portion comprising the protrusion 126 and the rim 128 with different heights along the periphery.

Further, the lower cover 300 has also a periphery corresponding to the periphery of the body 100. FIG. 4B is a perspective view showing a lower cover of the embodiment of a piezoelectric speaker. As shown in the figure, the lower cover 300 includes a disc-typed bottom 312 and a circular sidewall 310 formed on the periphery. Besides, a pair of holes 316 is formed through the disc-typed bottom 312 for electric wires to the piezoelectric transducer element 150 (shown in FIG. 2).

The body 100 and the lower cover 300 are combined by inserting an upper end 314 of the sidewall 312 of the lower cover 300 into the inside of the protrusion 126 extending downwardly along the lower periphery of the bottom portion 120 of the body 100 and fixing the upper end 314 to the rim 128 of the body 100 by a molding method using epoxy resins or a ultrasonic fusion method and the like. The combination of the body 100 and the lower cover 300 is stronger than the conventional press-fit means so that the piezoelectric transducer means therebetween might not loosen by vibration.

Referring to FIGS. 4A, 4B and 2, a metal disc 152 of the piezoelectric transducer element 150 is inserted between the upper end 314 of the lower cover 300 and the rim 128 located along the periphery of the lower plane 121 of the bottom portion 120.

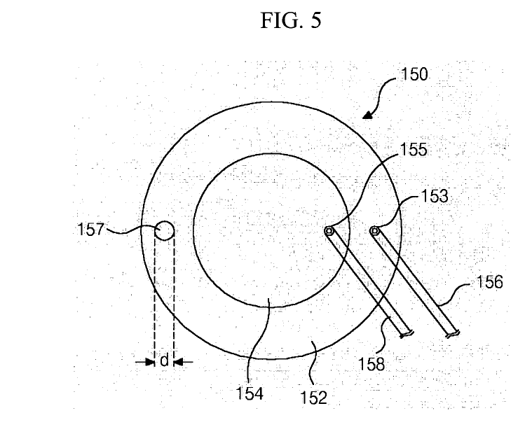

FIG. 5 is a plane view of a piezoelectric speaker according to a preferred embodiment of the present invention. As shown the figure, the piezoelectric transducer element 150 comprises the circular metal disc 152 having a passing hole 157 and the circular piezoelectric element 154 with a less diameter than that of the metal disc 152, wherein the piezoelectric element 154 is attached on one plane of the metal disc 152. The passing hole 157 is located out of the piezoelectric element 154.

The metal disc 152 can be made of materials having excellent mechanical properties such as durability and anti-corrosions, and particularly the metal disc 152 is made of materials selected from the group consisting of brass, stainless steel, and nickel alloy and the like. The piezoelectric element 154 can be manufactured from ceramics plated with silver on the surface. The piezoelectric element 154 is bonded to the metal disc 152 using adhesives.

Preferably, the piezoelectric element 154 has a diameter of about 24 to about 26 mm and a thickness of about 0.15 to 0.25 mm for generating effective sound pressures. Also, the metal disc 152 has preferably a diameter between the inner diameter and the outer diameter of the circular rim 128, more preferably about 50 mm because the periphery of the metal disc 152 should be fixed to the rim 128 positioned at lower plane of the bottom portion 120 of the body 100 by the upper end 314 of the sidewall 310 of the lower cover 300.

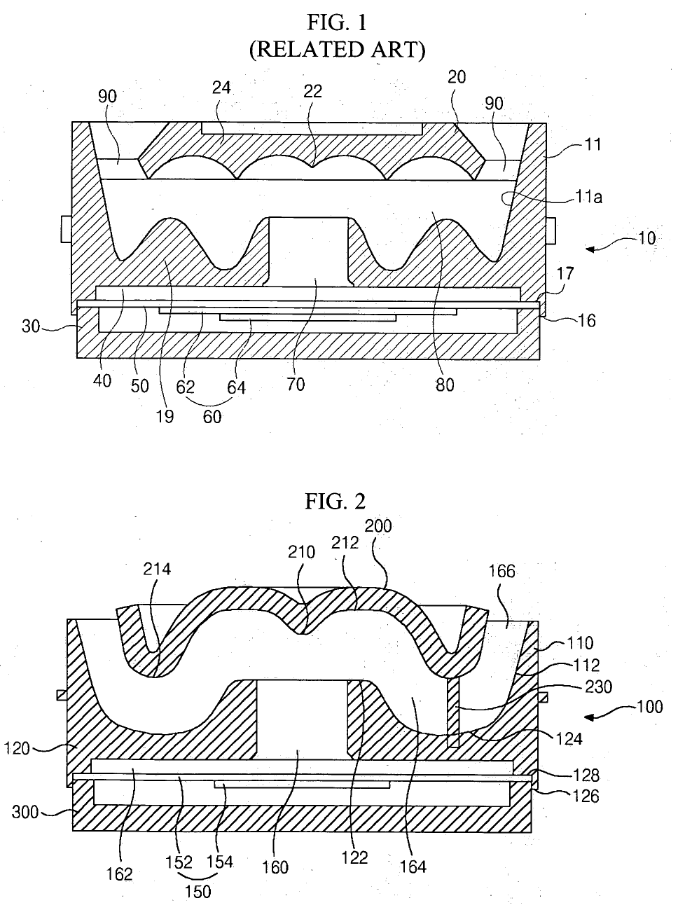

As mentioned above, the conventional piezoelectric speaker requires a separated diaphragm 50 (in FIG. 1) for generating a predetermined sound wave. On the other hand, the piezoelectric speaker according to the present invention has only the piezoelectric transducer element 150 so as to give rise to sound waves without the diaphragm. Accordingly, the piezoelectric speaker of the present invention has much simpler construction than the conventional one, and therefore much enhanced durability.

Especially, the passing hole 157 can be formed at the central point between the periphery of the piezoelectric element 154 and the periphery of the metal disc 152 for generating maximal or optimal sound waves from much trials and errors. Particularly, the passing hole 157 has a diameter d of about 4 to 6 mm for generating effective sound waves.

When electrical signal is applied to each of the metal disc 152 and the piezoelectric element 154, the whole of the piezoelectric transducer element 150 vibrates. For applying electric signals to the piezoelectric transducer element 150, wires 156, 158 are connected to the metal disc 152 and the piezoelectric element 154, respectively. Usually, the wires 156, 158 are connected to the metal disc 152 and the piezoelectric element 154 using soldering, preferably, bonding portions 153, 155 are treated with UV coating solutions so as to bond the wires 156, 158 firmly since the metal disc 152 and the piezoelectric element 154 are vibrating components. The bonded materials such as solder can be hardened in short time by using UV coatings, and conventional coating solutions can be used as coating paints.

Each of the bonding portions 153, 155 are positioned preferably on the same line around the center of the piezoelectric transducer element 150, and more preferably formed at about 170 to about 190 degrees away, most preferably at the opposite direction (180 degree away) from the center of the passing hole 157 so as to generate effective sound waves.

Referring to FIG. 3, when a lower-frequency electrical signal is applied from the outside, the piezoelectric transducer element 150 begins to vibrate, then air in the first space 162 formed between the body 100 and the piezoelectric transducer element 150 is vibrated so as to generate sound waves, and the generated sound waves are transmitted through the throttle hole 160 to the second space 164 formed between the body 100 and the reflection cover 200. As the sound waves are transmitted radially from the tip 210 positioned at the central portion of the reflection cover 200 in the second space 164, sound pressure are amplified and curved sound wave are formed by the wavy contours of the reflection cover 200 and the upper plane of the body 100, the curved shaped sound waves are discharged to the outside through a plurality of the sound discharge openings 166.

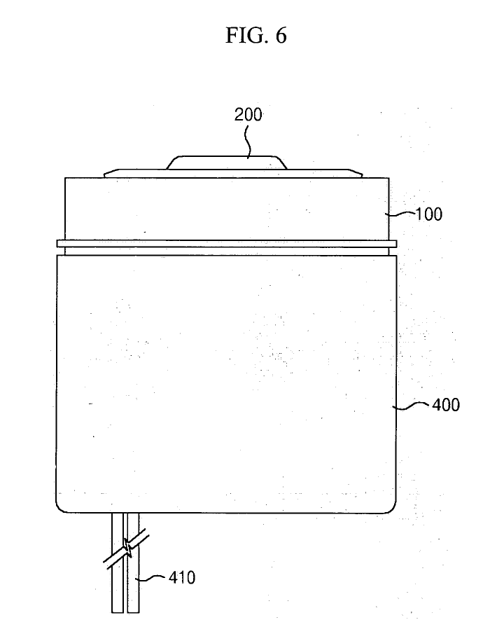

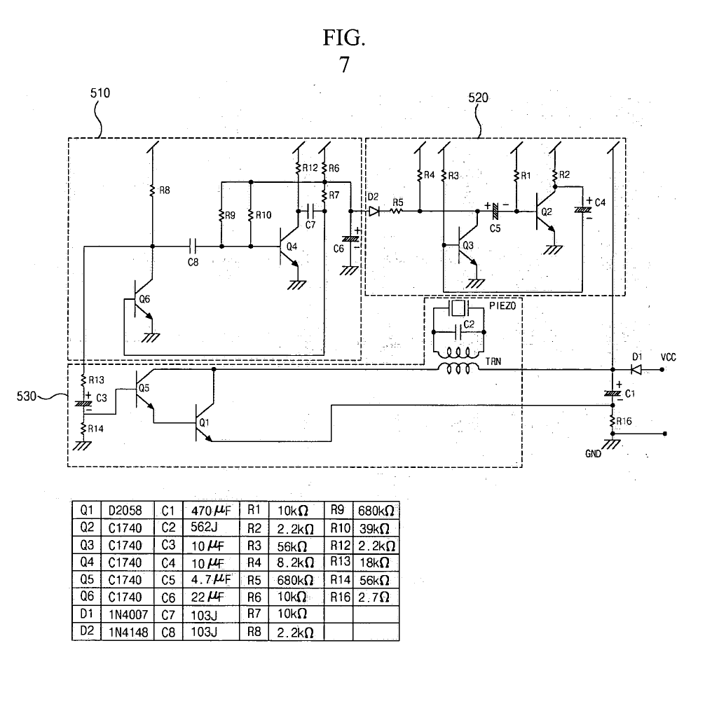

FIG. 6 is a side view of piezoelectric speaker mounted on a case 400 according to the present invention. As shown in the figure, a part of an outer sidewall of the body 100 is inserted to the case 400 by means of press fit. A wire 410 is extended from the lower portion of the case 400 to the outside for electrically connecting the case 400 to an electrical power supply (not shown).

Besides, a printed circuit board (PCB), which includes a circuit for converting the electrical signal applied from the outside electrical power supply into an electrical signal requiring for operating the piezoelectric speaker, is mounted on the case 400. FIG. 7 is an exemplary circuitry applying an electric signal to a piezoelectric speaker according to the present invention, the circuit includes an oscillating part 510, a wave-shape fixing part 920 and a wave-shape amplifying part 930.

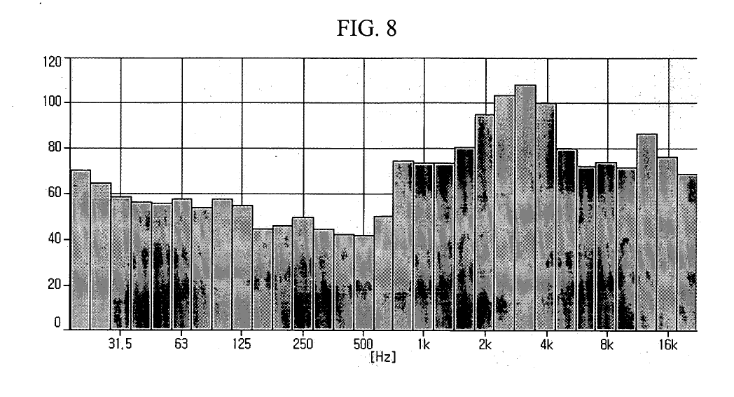

FIG. 8 is a graph showing output sound pressures in relation to changing a frequency of a piezoelectric speaker according to an embodiment of the present invention. As shown in the figure, the piezoelectric speaker of the present invention maintains stable sound pressures of at least 80 dB within the frequency range from 1.5 to 4.0 KHz. Especially, the piezoelectric speaker generates a maximal sound pressure of 108.1 dB at frequency of 3.15 kHz.

It will be apparent to those skilled in the art that various modifications and variations can be made in the fabrication and application of the present invention without departing from the spirit or scope of the invention. Thus, it is intended that the present invention cover the modifications and variations of this invention provided they come within the scope of the appended claims and their equivalents.

1. A piezoelectric speaker comprising:
a body including a bottom portion and a circular sidewall, the bottom portion having a throttle hole in a center thereof, wherein a upper surface from the throttle hole to side wall has a curve contour;
a reflection cover located over and spaced from the body, the reflection cover having a tip at a lower center and a lower plane having waving contours from the tip to a periphery of the reflection cover;
a means for fixing the body and the reflection cover;
a lower cover having a plate-shaped bottom portion and a sidewall formed on a periphery thereof, the lower cover being connected to the body; and
a piezoelectric transducer element inserted between the body and the lower cover, the piezoelectric transducer element including a metal disc having a passing hole and a piezoelectric element attached to the metal disc, each of the metal disc and the piezoelectric element connected to wires.

2. The piezoelectric speaker according to claim 1, wherein the upper contour of the bottom portion has a concave portion from a periphery top end of the throttle hole to the inner sidewall and the waving contours of the lower plane of the reflection cover are corresponding to the upper contours of the bottom portion.

3. The piezoelectric speaker according to claim 1, wherein the body and the lower cover are connected by a ultrasonic fusion or a molding using epoxy resins.

4. The piezoelectric speaker according to claim 1, wherein the metal disc is circular.

5. The piezoelectric speaker according to claim 1, wherein the metal disc made of materials selected from the group consisting of brass, stainless steel, or nickel alloy.

6. The piezoelectric speaker according to claim 1, wherein the passing hole are formed at the central portion between a periphery of the metal disc and a periphery of the piezoelectric element.

7. The piezoelectric speaker according to claim 1, wherein the passing hole has a diameter of about 4 to about 6.5 mm.

8. The piezoelectric speaker according to claim 1, wherein the piezoelectric element is circular.

9. The piezoelectric speaker according to claim 1, wherein the piezoelectric element has a diameter about 24 to about 26 mm.

10. The piezoelectric speaker according to claim 1, wherein the piezoelectric element has a thickness of about 0.15 to about 0.25 mm

11. The piezoelectric speaker according to claim 1, wherein the piezoelectric element is made of ceramics.

12. The piezoelectric speaker according to claim 1, wherein each of the metal disc and the piezoelectric element has a bonding portion to connect the metal disc and the piezoelectric element to the wires, and each of the bonding portion is formed on the same line around a center of the piezoelectric transducer element.

13. The piezoelectric speaker according to claim 1, wherein each of the metal disc and the piezoelectric element has a bonding portion to connect the metal disc and the piezoelectric element to the wires, and each of the bonding portion is positioned at 170 to 190 degrees away around a center of the piezoelectric transducer element from a center of the passing hole.

14. The piezoelectric speaker according to claim 12, wherein each of the bonding portion is positioned at 170 to 190 degrees around away around a center of the piezoelectric transducer element from a center of the passing hole.

15. The piezoelectric speaker according to claim 1, wherein each of the metal disc and the piezoelectric element has a bonding portion to connect the metal disc and the piezoelectric element to the wires and a surface of each of the bonding portion is coated.

16. The piezoelectric speaker according to claim 15, wherein the surface of each of the bonding portion are UV-coated.

17. The piezoelectric speaker according to claim 12, wherein a surface of each of the bonding portion is coated.

18. The piezoelectric speaker according to claim 1, further comprising a case surrounding a lower part of the body and whole of the lower cover.

19. A piezoelectric speaker comprising:
a body including generally circular side wall portion having a sloped inner side wall;
a bottom portion defining with the body a first chamber therebelow having a circular rim and a second chamber thereabove with the circular side wall, the bottom portion defining a throttle hole therethrough interconnecting the first and second chambers, a upper contour from the throttle hole to the side wall having only one concave;
a piezoelectric transducer element having a metal disc and a piezoelectric element longitudinally bonded underneath to the metal disc inserted in the first chamber;
a cover means fixed to the body in the first chamber and having a circular side wall thereof retaining the metal disc of the piezoelectric transducer element in positions by means of a peripheral top edge of the circular side wall coacting with the circular rim of the bottom portion and using a resin molding method or a ultrasonic fusion method; and
a reflection cover extending over the second chamber and, spaced from the bottom portion, the reflection cover having a contoured inner surface with a curved cross-sectional configuration with a protruding tip located adjacent to the throttle hole of the bottom portion and defining a plurality of discharging openings.
